(19) United States
(12) Patent Application Publication
(10) Pub. No.: US 2011/0240151 A1
(43) Pub. Date: Oct. 6, 2011

(54) FLUIDIC DEVICE

(75) Inventors: Scott T. Phillips, State College, PA (US); Nicole K. Thom, State College, PA (US); Hyeran Noh, Seoul (KR)

(73) Assignee: The Penn State Research Foundation, University Park, PA (US)

(21) Appl. No.: 13/076,736

(22) Filed: Mar. 31, 2011

Related U.S. Application Data
(60) Provisional application No. 61/319,583, filed on Mar. 31, 2010.

(51) Int. Cl. F15D 1/00

(52) U.S. Cl. 137/551; 137/561 R

(57) ABSTRACT

A fluidic device having a first layer with a first layer wicking channel and a second layer extending across the first layer and having a second layer functional wicking channel. The fluidic device can further include a third layer extending across the second layer, the third layer having a third layer functional wicking channel. The second layer functional wicking channel can have a different function than the third layer functional wicking channel and the functional wicking channels can afford for the fluidic device to be used as a timer, a battery, and/or a chemical assay.

### CROSS-REFERENCE TO RELATED APPLICATIONS

This application claims priority of U.S. Provisional Patent Application Ser. No. 61/319,583 filed Mar. 31, 2010, which is incorporated in its entirety herein by reference.

### FIELD OF THE INVENTION

The present invention is related to a fluidic device, and in particular to a fluidic device that can be used as a timer and/or a battery.

### BACKGROUND OF THE INVENTION

In the developing world, cost is a significant barrier to effective diagnosis.¹⁻⁴ At least partly in response to this barrier, paper-based microfluidic devices⁵⁻¹¹—and other paper-based detection platforms¹²⁻²³—are emerging as convenient and low-cost platforms for running assays with microliter volumes of fluids.⁶ Three-dimensional (3D) microfluidic paper-based analytical devices (μPADs)⁸ are particularly useful in that fluid movement in the x-, y-, and z-directions is afforded, and therefore, more assays can be accommodated on a smaller footprint than typical 2D, lateral-flow devices.⁵ In addition, 3D μPADs are: (i) exceedingly inexpensive; (ii) easily fabricated for rapid prototyping of new designs; (iii) made from abundant raw materials; (iv) conveniently incinerated for rapid disposal of hazardous waste; and (v) stand-alone devices—they do not require external pumps or other complicated equipment to move fluids within the devices.

However, 3D μPADs have heretofore been a nascent technology and substantial development is needed before their full capabilities can be realized. For example, certain useful features—such as the ability to control flow rate, interaction times between sample and reagents, and mixing of fluids—are well developed for polymer- and glass-based microfluidic devices, but similar technologies have been unavailable for μPADs. As such, a cost-effective μPAD that can provide controlled flow of liquid and accurate interaction times between a sample and a reagent would be useful for performing time-based assays and thus desirable.

### SUMMARY OF THE INVENTION

The present invention provides a fluidic device having a first layer with a first layer wicking channel therethrough and a second layer with a second layer functional wicking channel therethrough extending across the first layer. In addition, a third layer with a third layer functional wicking channel can be provided and extend across the second layer, the second layer functional wicking channel having a different function than the third layer functional wicking channel. In some instances, the first, second, and third layer wicking channels contain a cellulose material, for example and for illustrative purposes only a cellulose material such as paper.

The second layer functional wicking channel can contain a liquid-phobic portion, the liquid-phobic portion providing a delayed wicking rate through the second layer functional wicking channel. The liquid-phobic portion can contain a hydrophobic material, for example a paraffin wax. The third layer functional wicking channel can contain a signaling portion that is colorimetric, chemiluminescent, and the like.

In some instances, the second layer can contain a plurality of spaced apart second layer functional wicking channels with one of the wicking channels containing a first amount of a liquid-phobic material and another wicking channel containing a second amount of the liquid-phobic material. In addition, the third layer can contain a plurality of spaced apart third layer functional wicking channels with one wicking channel containing a first color signaling portion and another wicking channel containing a second color signaling portion. It is appreciated that the wicking channels of the third layer can be in fluid communication with the wicking channels of the second layer.

The second layer and the third layer may or may not each have a chemical assay wicking channel in fluid communication with each other, the chemical assay wicking channels affording for a chemical assay to be performed on a liquid provided to the fluidic device. In some instances, a second layer functional wicking channel can contain a salt and the salt in combination with a liquid in the second layer functional wicking channel can provide an electrolyte. In addition, the third layer can have a pair of spaced apart functional wicking channels in fluid communication with the second layer functional wicking channel containing the salt, with one of the third layer functional wicking channels containing a first metal salt and another of the third layer functional wicking channels containing a second metal salt.

A fourth layer can be provided and extend across the third layer, the fourth layer containing a first metal and a second metal in fluid communication with the first metal salt and the second metal salt, respectively, of the third layer. In such instances, the second, third, and fourth layers afford for a battery when a liquid wicks through the second and third functional layer wicking channels and comes into contact with the first and second metals.

A sound generating device can be placed into electrical contact with the first metal and the second metal, and thereby be operable to generate an audible signal when the liquid wicks through the second and third layers and comes into contact with the first and second metals. The sound generating device can be a piezoelectric buzzer and the like. In addition to, or replacing the sound generating device, a light generating device can be in electrical contact with the first metal and the second metal, the light generating device operable to generate a visible signal when the liquid wicks through the second and third layers and comes into contact with the first and second metals. In some instances, the light generating device can be a light emitting diode (LED).

### BRIEF DESCRIPTION OF THE DRAWINGS

FIG. 1 is a schematic illustration of a fluidic device according to an embodiment of the present invention;

FIG. 2 is a graph illustrating time for a liquid to wick through a wicking channel as a function of the quantity of paraffin wax within the wicking channel;

FIG. 3 is a schematic illustration of: a) a fluidic device according to an embodiment of the present invention; and b) a graph illustrating time required for water to pass through a wicking channel as a function of humidity;

FIG. 4 is a schematic illustration of a fluidic device according to an embodiment of the present invention;

FIG. 5 is a schematic illustration of a fluidic device according to an embodiment of the present invention;

FIG. 6 is a schematic illustration of a fluidic device according to an embodiment of the present invention;

FIG. 7 is a schematic illustration of a fluidic device according to an embodiment of the present invention;

FIG. 8 is a schematic illustration of a fluidic device according to an embodiment of the present invention;

FIG. 9 is a schematic illustration of a fluidic device according to an embodiment of the present invention;

FIG. 10 is a schematic illustration of a fluidic device according to an embodiment of the present invention;

FIG. 11 is a schematic illustration of: a) a fluidic device having a buzzer; and b) a fluidic device having a light;

FIG. 12 is a schematic illustration of a fluidic device according to an embodiment of the present invention;

FIG. 13 is a schematic illustration of a fluidic device according to an embodiment of the present invention; and

FIG. 14 is a schematic illustration of a fluidic device according to an embodiment of the present invention.

### DETAILED DESCRIPTION OF THE PRESENT INVENTION

The present invention provides simple, low-cost fluidic devices that can be used as timers, batteries, etc. and a process for fabricating such fluidic devices. As such, the present invention has utility as a timer and/or a battery.

The fluidic devices can indicate an endpoint of a time-based assay and can be incorporated as part of a two- or three-dimensional microfluidic, paper-based analytical devices (μPADs). In addition, the fluidic devices can be built directly into μPADs and do not require starting, stopping, reset buttons, or maintenance, unlike external timers that are typically used to track time-dependent assays. In addition, the fluidic devices can serve as a battery and be used to afford an audible and/or visible signal, for example when the endpoint of a time-based assay has occurred.

The fluidic devices in the form of fluidic timers can consist of two components: (i) paraffin wax-based meters that control the wetting properties of the paper and ultimately, the time required for a sample to wick through a conduit or channel within the μPAD; and (ii) signaling features that indicate when the specified time for the assay has been reached. By changing the meter, that is by increasing or decreasing the quantity of paraffin wax in the paper, the timer can be programmed for any time period within the range of, for example, 1 minute to 2 hours. The fluidic timers start automatically when a sample is introduced into a μPAD, and indicate clearly when the results of time-dependent assays are ready for inspection and quantification. In addition, since the fluidic timers depend on the wicking rate of the sample within the μPAD, they can automatically calibrate themselves for differences in wicking rate caused by changes in environmental humidity. The fluidic timers can be at least 97% accurate with respect to programmed time and can exhibit at least 90% precision as measured by individuals with no prior experience using μPADs.

The fluidic timers can function in daylight by providing colorimetric responses and/or in the dark by providing chemiluminescent signals. An audible alarm can also be provided when an endpoint of an assay has been reached, thereby enabling an operator to perform tasks while the assay is running. In this manner, removing external timers from the list of equipment that is required to conduct an assay can eliminate the logistical burden of pairing timers with devices when running multiple assays simultaneously.

The fluidic timers can be provided with a battery attached thereto, the battery affording for an audible and/or visible signal to be provided to an individual, for example, through the use of a buzzer, light emitting diode, and the like. In the alternative, the fluidic device can serve as a battery itself to serve as the power for a buzzer, LED, etc.

For the purposes of the present invention, the terms “wick”, “wicks” and “wicking” are defined as a liquid traversing through a porous material via capillary action. The term wicking rate is defined as a distance traversed by a liquid wicking through a porous material divided by a time to traverse the distance.

An inventive fluidic device can have a first layer with a first layer wicking channel therethrough and a second layer extending across the first layer, the second layer having a functional wicking channel therethrough. In addition, a third layer can be included and have a third layer functional wicking channel therethrough, the second layer functional wicking channel having a different function than the third layer functional wicking channel. For the purposes of the present invention, the term “functional wicking channel” is defined as a wicking path through a layer of the device that functions or operates differently or in addition to a standard wicking channel that simply wicks fluid therethrough.

For example and for illustrative purposes only, a functional wicking channel can be a wicking channel that delays wicking of a fluid therethrough when compared to a standard wicking channel. In addition, a functional wicking channel can provide a visible signal such as a color. Other examples of functional wicking channels include a chemical assay wicking channel that can perform a chemical assay on a liquid provided to the fluidic device, an electrolyte wicking channel that can provide an electrolyte for a battery when a liquid is present, and the like.

The wicking channels can contain a cellulose material, for example paper, that affords for a fluid to wick therethrough as is known to those skilled in the art. As such, the second layer functional wicking channel can include paper that contains a liquid-phobic portion, the liquid-phobic portion providing a delayed wicking rate through the second layer functional wicking channel. The liquid-phobic portion can include a hydrophobic material, for example and for illustrative purposes only, a paraffin wax.

In some instances, the third layer functional wicking channel can contain a signaling portion, the signaling portion being colorimetric, chemiluminescent, and the like.

In one embodiment of a fluidic device, the second layer can contain a plurality of spaced apart second layer functional wicking channels with one of the wicking channels containing a first amount of a liquid-phobic material and another of the wicking channels containing a second amount of the liquid-phobic material. In addition, the third layer can contain a plurality of spaced apart third layer functional wicking channels with one of the third layer wicking channels containing a first color signaling portion and another of the wicking channels containing a second color signaling portion.

The third layer wicking channels can be in fluid communication with the second layer wicking channels such that the time required for a liquid to wick through one of the wicking channels in the second layer is signaled by a first color and the time for the liquid to wick through another wicking channel of the second layer is signaled by a second color. In addition, the plurality of spaced apart functional wicking channels in the second or third layer can include one or more chemical assay wicking channels that afford for a chemical assay on the liquid that wicks therethrough.

In another embodiment of the fluidic device, the second layer functional wicking channel can contain a salt that affords for an electrolyte when a liquid wicks through the second layer functional wicking channel. Such a functional wicking channel can be in liquid communication with a pair of spaced apart third layer functional wicking channels with one of the third layer functional wicking channels containing a first metal salt and another of the functional wicking channels containing a second metal salt. In addition, and to afford for a battery, the fluidic device can further include a fourth layer that extends across the third layer and has a first metal and a second metal in fluid communication with the first metal salt and the second metal salt, respectively. In this manner, the components of a battery as is known to those skilled in the art are provided and can afford for electrical power for a signaling device such as a piezoelectric buzzer, a light emitting diode (LED), and the like.

It is appreciated that additional layers can be included within the fluidic device such that a liquid-phobic wicking channel can be used in combination with a colorimetric wicking channel and/or an electrolyte wicking channel and the time required for a chemical assay to be completed and/or for the liquid to pass from a first point or location to a second point or location can be provided by a color signal, a light signal, a sound signal, etc.

In order to better illustrate the present invention, and yet not limit the scope of the invention in any way, a number of examples of the use and/or manufacture of inventive fluidic devices are described.

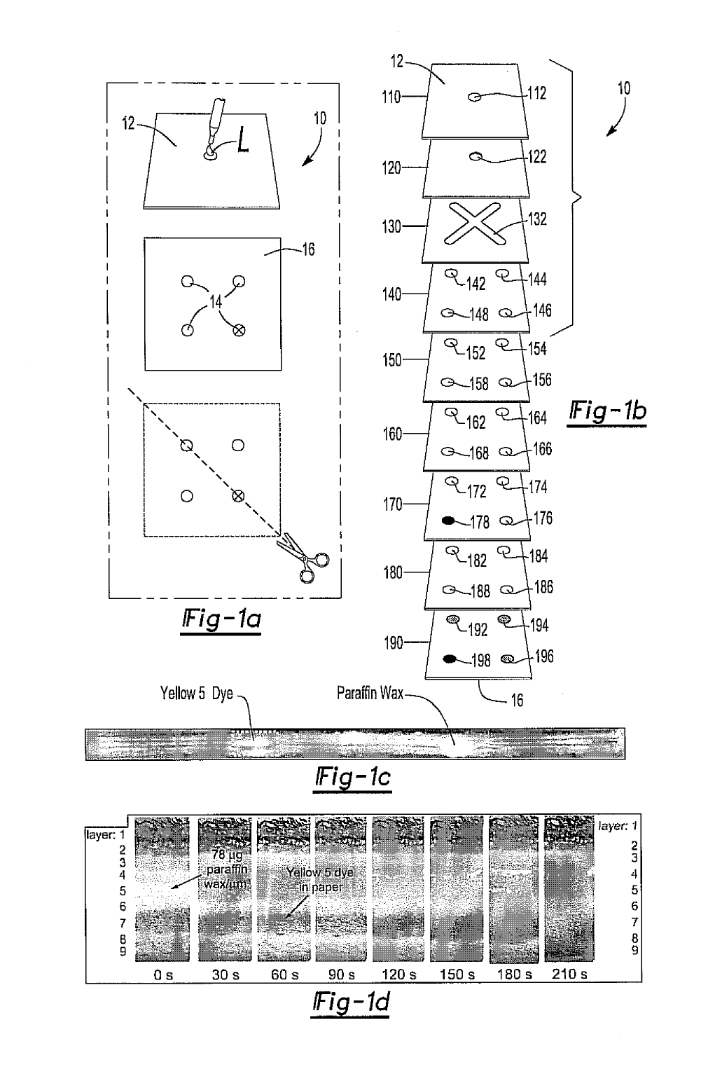

Referring now to FIG. 1a, an illustration of a standard 3D μPAD is shown generally at reference numeral 10. The 3D μPAD 10 can distribute a desired and predefined amount of liquid/sample L (e.g. 10 μL) from a top or front 12 of the device 10 into four detection zones 14 on a bottom or back 16 of the device, where the sample interacts with reagents that can be pre-deposited onto a bottom layer prior to assembly. For example and for illustrative purposes only, reagents in the example shown in FIG. 1 can form a two-enzyme assay that measures a glucose level in a sample. In addition, the assay uses glucose oxidase to convert glucose and oxygen into gluconic acid and hydrogen peroxide, and uses horseradish peroxidase, diethyl phenylenediamine, and 1-chloro 4-naphthol to generate a blue indamine dye from the hydrogen peroxide produced by glucose oxidase.²⁴

The intensity of color can depend on the initial concentration of glucose in the sample, and on the overall time the reagents are in contact with the liquid L. For example and for illustrative purposes only, inspection of the device after 80 seconds (s) can reveal a light color and after 210 s (3 min 30 s) the color can become more intense. As such, this illustrative time-based assay can require 3.5 min for a 10-μL sample of 10 mM of glucose in double distilled water (ddH₂O) to distribute from the top 12 of the device 10 to the bottom 16 and for the assays to develop sufficient color. In addition, one of the detection zones can provide a different color when a desired time, e.g. 210 s, has elapsed from the time the liquid L is applied to the top 12.

This type of colorimetric assay can be quantified by photographing or scanning the device after a defined period of time, and then measuring the intensity of color in the detection zones using the histogram function in Adobe® Photoshop®.²⁵ It is appreciated that this method of quantification can require development of a calibration curve using known concentrations of glucose, but can be convenient since the calibration curve requires development only once. In addition, the results of the assays can be obtained in the field and sent by phone to trained technicians in the clinic (so-called Telemedicine).²⁵ However, a disadvantage can be that the duration of each assay must be monitored carefully so that the assay does not develop longer than the period of time used to generate the calibration curve.

Incorporation of such a fluidic timer into a μPAD can offer a solution to the tedious task of tracking the progress of a time-based assay and FIG. 1b shows a more detailed example design for the 3D μPAD 10 that includes a fluidic timer. In this example, the 3D μPAD 10 can have a plurality of layers 110, 120 . . . 190 with a plurality of wicking channels through the layers. For example, the first layer 110 can have a wicking channel 112, followed by a second layer 120 with an aperture 122 that may or may not have a wicking material therewithin. In addition, the second layer 120 can be a layer of tape (tape layer) that affords for attaching the first layer 110 to a third layer 130.

The third layer 130 can have an elongated wicking channel 132, for example in the shape of an ‘X’, such that liquid provided through the single wicking channel 112 can wick therethrough and be traversed to a plurality of apertures 142-148 of a fourth layer 140. Again, the fourth layer 140 can be a tape layer with apertures 142-148 having wicking material therewithin, however this is not required. A fifth layer 150 can extend across the fourth layer 140 and have corresponding or complimentary apertures 152-158. In addition, the aperture 158 can be a functional wicking channel containing a liquid-phobic portion operable to delay wicking of the liquid therethrough.

A sixth layer 160 can be a tape layer with apertures 162-168 that align with apertures 152-158, the tape layer affording for attachment of the fifth layer 150 to a seventh layer 170 having apertures 172-178. In addition, the aperture 178 can be a functional wicking channel containing a dye material, that upon coming into contact with liquid, will wick through an eighth layer 180 to a ninth layer 190. The eighth layer 180 can be a tape layer with apertures 182-188 and the ninth layer 190 can have apertures 192-198. Upon wicking through the ninth layer 190, the dye material can provide a visual signal to an individual viewing the bottom 16 of the device 10. It is appreciated that by controlling the amount of liquid-phobic material in the wicking channel 158, the wicking rate of the liquid from aperture 112 to aperture 198 can be controlled and a timer can be provided.

FIG. 1c provides a photograph of a side cross-sectional view along the dotted line across the device 10 shown in FIG. 1a and FIG. 1d provides a time lapse of the device 10 operating as a timer. As labeled in the photographs, a paraffin wax was incorporated within the fifth layer functional wicking channel 158 and Yellow 5 dye was originally present within the seventh layer functional channel 178 and eventually wicked through the wicking channel 198.

The fluidic device 10 used for the photographs in FIGS. 1c and 1d was generally 20-mm wide×20-mm long×1.6-mm thick, with each layer within the μPAD generally 0.18-mm thick and each circular region or aperture within each layer generally 2.4-mm in diameter. The device 10 contained a single entry point 112 and four exit or end points 192-198. The functional wicking channel 158 had 78 μg of wax per μm⁻³ of paper deposited therein with the wax serving as a meter in the paper and slowing mass transport of the liquid through the conduit by altering wetting properties of the channel 158. This type of meter can be tuned to increase or decrease the rate of absorption of a liquid through such a functional wicking channel by increasing or decreasing the quantity of wax per volume of paper. Ultimately, the change in wax quantity affects the time required for a liquid or sample to pass from the top of the device to the bottom, thus creating a timer.

It is appreciated that a timer can provide a signal when an end point of an assay has been reached. In some instances (e.g., as shown in FIG. 1d), the fluidic timer includes dye in a seventh layer which can be dissolved by the liquid or sample and distributed to the bottom or ninth layer once the liquid or sample has passed through the metering region in the fifth layer. Distribution of the dye to the bottom layer as shown in FIG. 1d can provide a colorimetric signal that indicates completion of the assay.

Regarding fabrication and/or manufacture of a fluidic timer as shown in FIGS. 1a-1d, Synthetic food dyes (Assorted Food Colors & Egg Dye; Wal-Mart brand) were used to give colorimetric responses and to track the distribution of fluids within a device. The synthetic food dyes contain the following components: RED 40 (Disodium salt of 6-hydroxy-5-[(2-methoxy-5-methyl-4-sulfophenyl)azo]-2-naphthalenesulfonic acid), BLUE 1(Disodium salt of ethyl[4-[p-[ethyl(m-sulfobenzyl)amino]-α-(o-sulfophenyl)benzylidene]-2,5-cyclohexadien-1-ylidene](m-sulfobenzyl)ammonium hydroxide inner salt plus p-sulfobenzyl and o-sulfobenzyl salts), YELLOW 5 (Trisodium salt of 4,5-dihydro-5-oxo-1-(4-sulfophenyl)-4-[4-sulfophenylazo]-1H-pyrazole-3-carboxylic acid), and GREEN (which is a 1:1 mixture of YELLOW 5 and BLUE 1). The dyes were used as 1:5 mixture of dye to distilled water.

CleWin® (PhoeniX Software, The Netherlands) was used for designing patterns in paper and adhesive tape. Designs were saved as PostScript files, which were converted into PDF files for printing. A Xerox Phaser 8560N color printer was used for depositing solid wax onto paper in defined patterns according to the procedures reported by Carillho et al.²⁶ Printing quality was set at the highest resolution for photo quality printing. Printed papers were placed on a hot plate set at 150° C. for two minutes. During this time, the wax ink penetrated through the paper in the z-direction to create hydrophobic barriers within the paper. Solid inks are composed of a mixture of hydrophobic carbamates, hydrocarbons, and dyes; when combined, these ingredients melt at 120° C. The patterned paper was cooled to room temperature, and was ready for further processing after 10 s.

An Epilog Laser (Epilog Mini, 45 W) CO₂ laser cutter was used to cut holes in double sided adhesive tape (ACE plastic carpet tape 50106). The patterns for these holes were designed in CleWin®, as described previously.²⁷

Paraffin wax from Sigma Aldrich was used as received. Paraffin wax is a mixture of hydrocarbons obtained from petroleum fractions. The paraffin wax used in these experiments had a melting point of 58-62° C. Hexanes (Sigma Aldrich) were used to dissolve the paraffin wax; solutions were sonicated for up to 10 min to facilitate complete dissolution of the wax into hexanes. Solutions (0.4 μL; concentrations ranging from 1-55 mg mL⁻¹) of wax in hexanes were deposited (using a micropipette) onto hydrophilic regions of paper that were 2.4-mm diameter×0.18-mm thick. Once the hexanes had evaporated (ca. 30 min), another 0.4 μL of the same wax solution was deposited on the bottom of the same hydrophilic region (the opposite side of the paper). The paper was air-dried at room temperature for 1 h in a chemical fume hood.

The 3D μPADs were assembled using procedures similar to those described by Martinez et al.²⁷ The holes in the tape were filled with Whatman Chromatography Paper #1 that had dimensions equal to the size of the holes. The assembled 3D μPADs were compressed with a rolling pin by passing the rolling pin over the devices three times with pressure approximately equal to that required for rolling dough.

Colorimetric signaling components were prepared by depositing 1-μL solutions of a dye into the appropriate 2.4 mm×0.18 mm hydrophilic disk of paper on the desired layer of patterned paper (e.g., layer 7 in FIG. 1c). The paper was dried in air for 24 h, after which the layer of patterned paper was incorporated into the 3D μPAD.

Returning to FIG. 1d, a demonstration of a fluidic timer in the context of an assay that measured the concentration of glucose in a sample of water is shown. In this experiment, a 10-μL sample of 10-mM glucose in ddH₂O passed from the top of the device to the three detection regions 24 in 56 s±9 s (N=7). However, this assay requires additional time to develop completely, and the appropriate incubation period is indicated by the appearance of Yellow 5 in the timer region 28, which occurs after 202 s±15 s (N=7).

Regarding time of operation, the total time (Tₜₒₜₐₗ) required for a sample to pass through the timer conduit and activate the signal in the bottom layer of the 3D μPAD can be described by Equation (1):

Tₜₒₜₐₗ=T_{distribution}+Tₘₑₜₑᵣ+T_{post meter}+T_{observation} (1)

with Tₜₒₜₐₗ depending on the wicking rate of the sample through four regions of the timer: (i) the distribution channels (T_{distribution}), which include all of the sections of hydrophilic paper that precede the metering layer; (ii) the metering region (Tₘₑₜₑᵣ), which involves wetting of the metering region and passage through that layer of paper; (iii) post-metering regions (T_{post meter}), which include all layers of hydrophilic paper after the metering region, except the last layer (these regions include layer 7 in FIG. 1c, which contains Yellow 5 as the signaling component for the timer); and (iv) the observation layer (T_{observation}), which is the bottom layer of the device where the signal (Yellow 5) appears and indicates the endpoint of the assay.

It is appreciated that details of the last time period, T_{observation}, are of practical importance when using fluidic timers. In this example, T_{observation} was defined as the time for the signal (Yellow 5) to fill the white hydrophilic region on the bottom layer of the device. It is further appreciated that determining precisely when the white hydrophilic region has filled with dye impacts the accuracy of the fluidic timers and ambiguity can arise in determining when the observation zone has filled completely with dye.

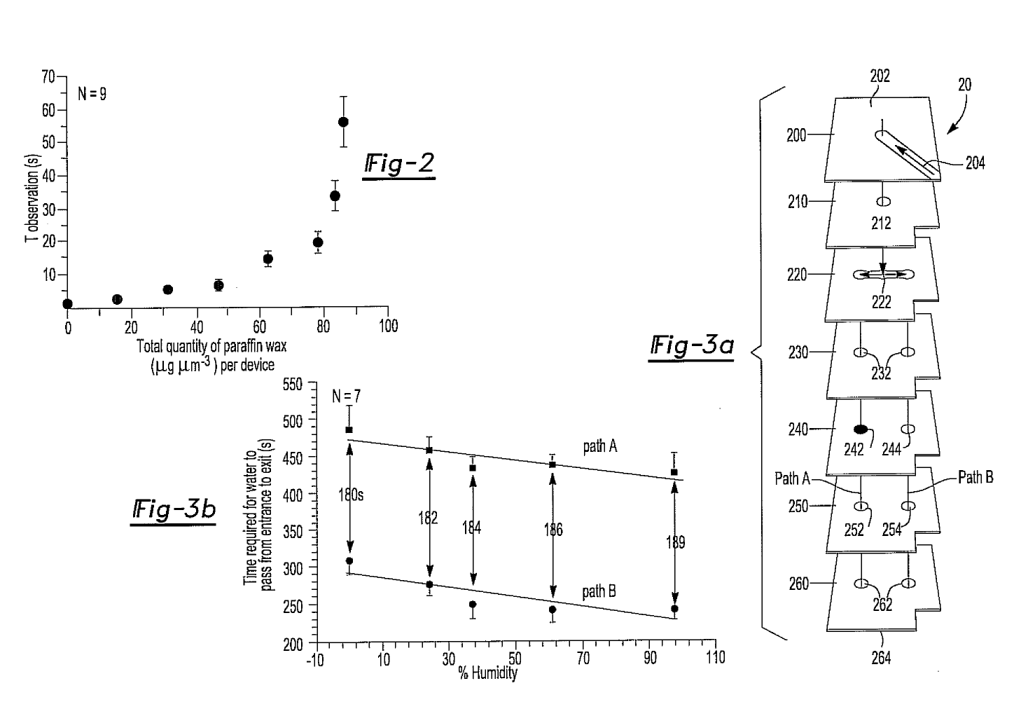

It is appreciated that most assays will require less than an hour, and therefore T_{observation} will be under 30 s. In addition, ambiguity in estimating when the observation zone has been filled with dye can be the largest source of error in fluidic timers, but fortunately the error decreases as the set point of the timer decreases as observed from the smaller error bars for lower times as shown in FIG. 2 which provides a graph of T_{observation} as a function of the quantity of wax within a wicking channel.

Overall, meters in 3D μPADs were provided that could distribute fluid to an end point of the 3D μPAD in times as short as 1 min and as long as 2 h. In addition, meters were provided that could distribute fluid to the end point at 30 s intervals within the range of 1 min and 2 h. While the dynamic range of fluidic timers was large (i.e., 1-120 min), it is appreciated that the accuracy and precision of a fluidic timer is critical. As such, accuracy of fluidic timers was evaluated with the timer 10 shown in FIG. 1 representative of accuracy testing and measurements showing liquid or sample wicked from the entry point 112 of the 3D μPAD to the endpoint 198 in 202±15 s (N=7). The timer 10 was designed to indicate the end of the assay after 200 s (Tₜₒₜₐₗ), and therefore was accurate in 99% of the runs. The fluidic timer 10 was also precise with deviation from the average fill time (Tₜₒₜₐₗ) being only 7%.

A degree of bias was postulated to be present in the measurements due to time measurements being performed by individuals trained in this technology. As such, individuals with no prior experience using μPADs were employed to measure Tₜₒₜₐₗ for 3D μPADs representative of the device 10 shown in FIG. 1. The average Tₜₒₜₐₗ measured by untrained individuals was 194±19 s and corresponds to an accuracy of 97% with a precision of 90%. As such, time values acceptable for running quantitative, and certainly semi-quantitative, time-based assays on paper were provided by the μPADs.

The rate of wicking within two-dimensional (2D) μPADs can depend on characteristics of the paper, dimensions of channels, viscosity of sampling fluid, and humidity of the environment of an assay. It is appreciated that the rate of wicking within 3D μPADs can be even more complicated with rate variable factors including: (i) evaporation (which can be a factor on the exterior of 3D μPADs, but likely not significant in interior channels); (ii) environment humidity; (iii) viscosity of the liquid/sample; (iv) pore size within the paper; (v) length and width of a fluidic channel in the paper; (vi) rate of absorption into different layers of a 3D μPAD; (vii) and surface roughness and contact angle of the paper (both of which affect the wetting properties of the paper).

Humidity can be a particularly important external factor and humidity-induced changes in wicking rate can have pronounced effects on the time required for a liquid/sample to reach a reagent for an assay. However, inventive fluidic timers of the instant invention can be automatically calibrated for humidity related changes in wicking rates. For example, FIG. 3a shows a design of a 3D μPAD 20 used to demonstrate such a self-calibrating feature. The 3D μPAD 20 had a top 202 and a plurality of layers 200-260. In addition, liquid was wicked inwardly from a corner 204 to a central region that was in fluid communication with a wicking channel 212 of a second layer 210. A third layer 230 had an elongated wicking channel 222 that afforded for liquid to wick to two separate wicking channels 232 of a fourth layer 230. The liquid subsequently traversed a path A and a path B, the path A having a liquid phobic-portion in the form of wax within a functional wicking channel 242 of a fifth layer 240 and path B not having a liquid-phobic portion through the path.

It is appreciated that the effects of humidity on wicking rate will be most pronounced on a top layer of the device which has a long hydrophilic channel open to the air and less pronounced on the interior of a 3D μPAD which is partially sealed by adhesive tape. In the device 20 shown in FIG. 3a, the effects of humidity on wicking rate were essentially uniform in 96.3% of the wicking distance (FIG. 3b). Stated differently, absolute fill times (Tₜₒₜₐₗ) for both conduits changed proportionally to one another as the humidity of the environment changed. As a consequence, the difference in fill times (Tₜₒₜₐₗ) between the two conduits remained fairly constant at 184±3 s, independent of the level of humidity (FIG. 3b).

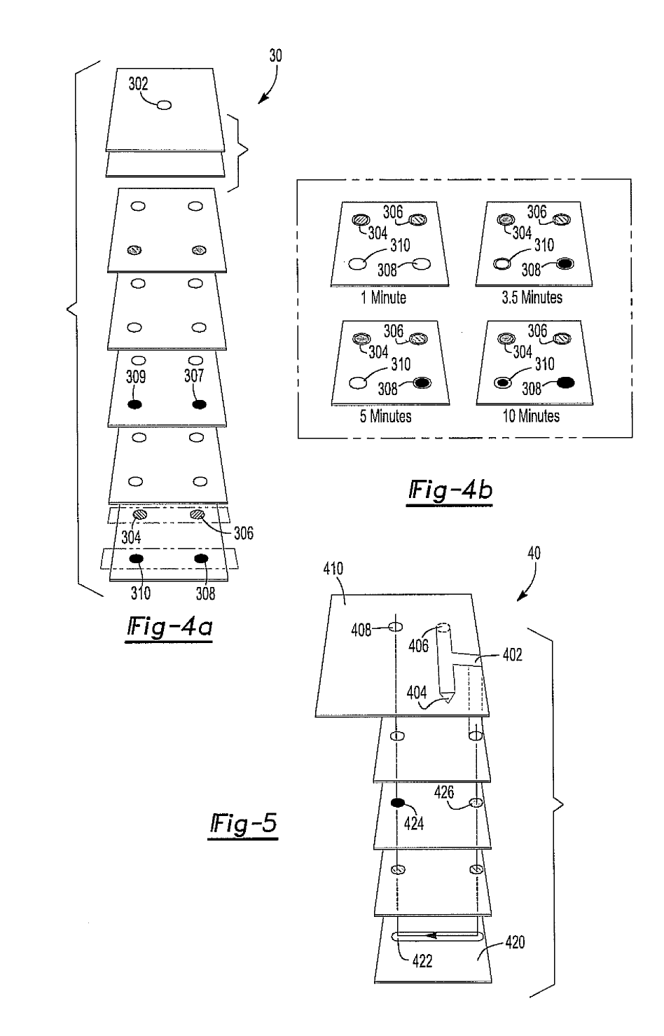

Fluidic timers for running more than one assay on a single device are also provided. It is appreciated that running more than one assay on a single device can be complicated, however the example fluidic device 30 shown in FIG. 4 demonstrates that timing of multiple simultaneous assays can be accomplished using one fluidic timer incorporated for each assay on a device. For example, the device 30 can have one entry point 302 and four exit points 304-310 with the two pathways leading to exit points 304 and 306 containing assay reagents, the pathway leading to exit point 308 having a first amount of a liquid-phobic material at 307 and the pathway leading to exit point 310 having a second amount of a liquid-phobic material at 309. In this manner, the pathway from 302 to 308 can provide a first timer associated with an assay conducted in the pathway from 302 to 306 (FIG. 4b), and the pathway from 302 to 310 can provide a second tinier associated with an assay conducted in the pathway from 302 to 304 (FIG. 4b). It is appreciated that this type of design can minimize logistical burden that is associated with time-based assays, and enhances the multiplexing capabilities of μPADs.

It is appreciated that fluidic timers are not limited to 3D μPADs, i.e. 2D lateral-flow devices accommodate fluidic timers as well. FIG. 5 depicts one example of a fluidic timer 40 on a 2D μPAD. In this case, the timer 40 is constructed in the form of a 3D μPAD, but its dimensions occupy only 27% of the total surface area on a back 420 of the 2D lateral-flow μPAD, i.e. the fluidic timer is an auxiliary feature on this device. When the entry point 402 (the bottom of the T-shaped channel) of the 2D μPAD is dipped into a sample, the sample distributes through the device by capillary action and travels laterally to a diamond-shaped detection zone 404 (where reagents for measuring the level of glucose in the sample were pre-deposited) and to the opposite circular endpoint 406. At the circular endpoint 406, the sample wicks in the z-direction through a meter to the bottom 420 of the fluidic timer 40, along an elongated wicking channel 422 and up through a conduit containing a dye (e.g. Yellow 5 dye) at 424 to an aperture 408 on a front 410 of the device 40. When this region turns from a first color to a second color, e.g. from white to orange, the assay is complete. In addition, it is appreciated that a desired amount of wax can be within a wicking channel, e.g. at 426, in order to control and/or delay the wicking rate and provide a desired elapsed time from the moment the liquid is placed into contact with the entry point 402 until the aperture 408 exhibits a different color afforded by the dye.

In some locations in the developing world, electricity is intermittent, or non-existent, and although colorimetric fluidic timers provide unambiguous stop times during the daylight, they cannot be used for running time-based assays in the dark. Obviously, diagnoses must be made at night as well as during the day, so there are compelling reasons to develop inexpensive diagnostic devices that function in daylight and at night.

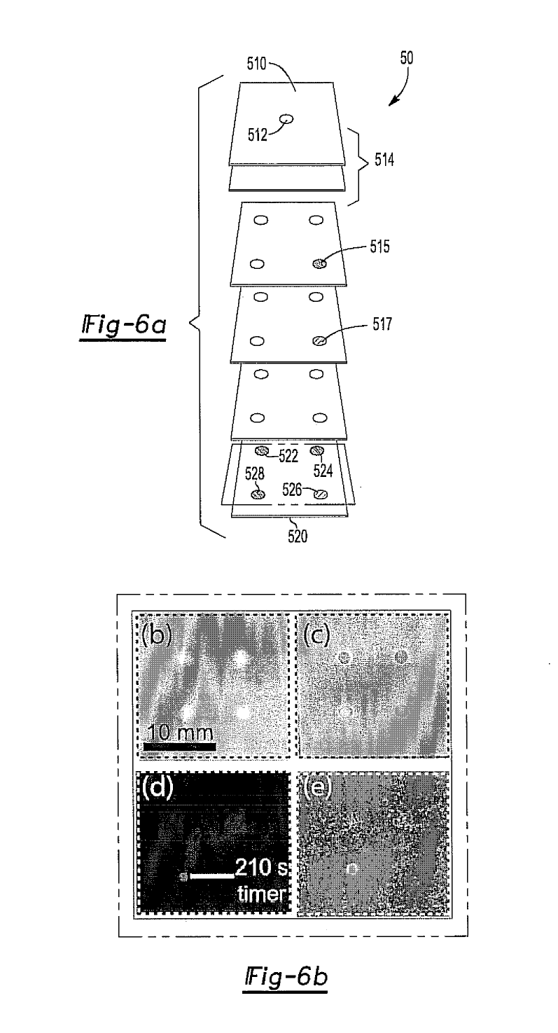

Turning now to FIG. 6, a strategy for running time-dependent assays in the dark is shown. In particular, a 3D μPAD 50 shown in FIG. 6a provides calorimetric outputs and chemiluminescent signals that can be used to indicate the endpoints of the assays in the dark. In particular, the device 50 can have a front 510 with single entry point or wicking channel 512, a liquid distribution section 514 that wicks liquid from the entry point 512 to a plurality of wicking channels in lower or subsequent layers, for example as shown and discussed in FIGS. 1 and 3. In addition, a pathway from the entry point 512 to an exit point 526 can have a liquid-phobic portion, e.g. at 515, and a chemiluminescent portion, e.g. at 517, that affords for a chemiluminescent signal at a desired lapsed time. It is appreciated that such a signal can prompt an operator to take a flash-photograph of the device 50 using a camera-equipped cellular phone as illustrated in FIG. 6b (for telemedicine).²⁶

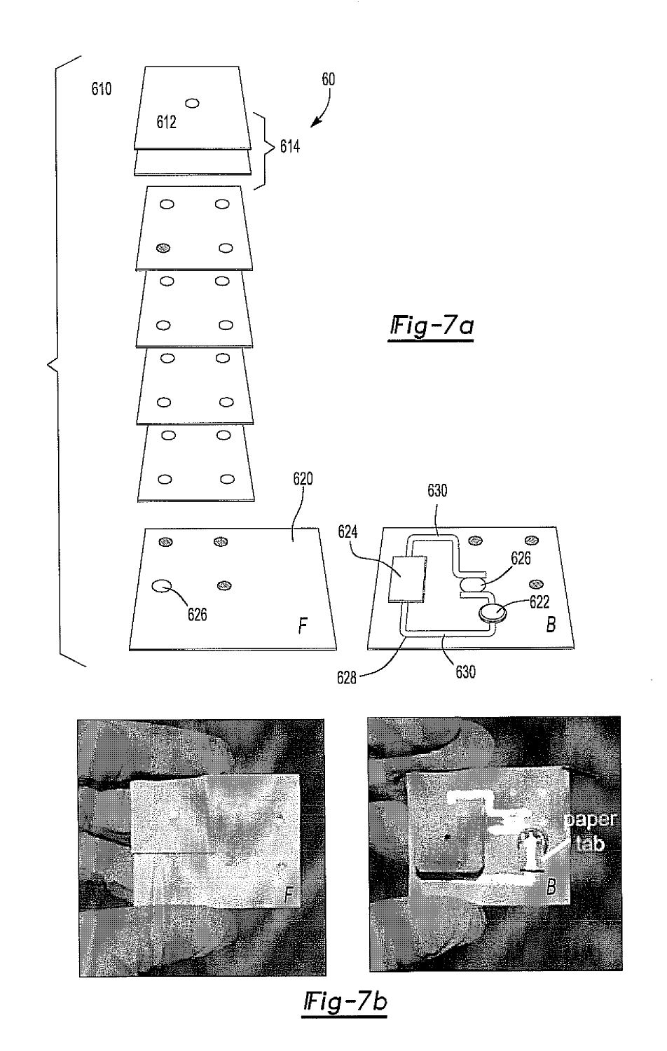

Electronic timers are able to create an audible signal, and an inventive fluidic timer is provided to do the same, rather than providing only a colorimetric response. FIG. 7 illustrates a fluidic timer 60 incorporating an audible signal into time-based assays on 3D μPADs. As such, the timer 60 can provide colorimetric outputs and audible signals such as a buzzer that indicate the endpoints of the assays and prompt an operator to read the assays.

To create the audible signals, conductive wires 630 were drawn on a last layer 620 of a 3D μPAD 60 using acrylic based silver conductive pens (FIGS. 7a and 7b).^{42,43} The bottom layer 620 of the device 60 was also equipped with a lithium battery 622 (1.55 V) connected to a piezo buzzer 624 with an internal drive. Sodium chloride (1.2 μmol) was deposited into a timer observation zone 626 prior to assembling the device 60 (FIG. 7a). When the sodium chloride became wet from liquid wicking from an entry point 612 on a front 610 of the device 60, a conductive solution was afforded which completed an electrical circuit 628 and the piezo buzzer 624 was activated.

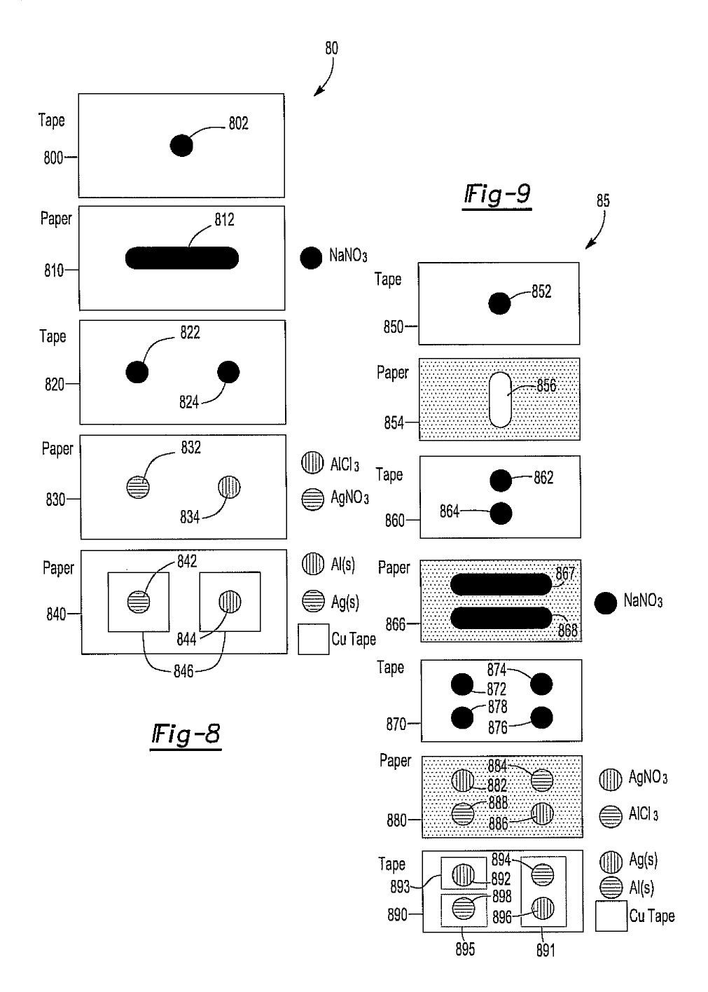

Rather than have an external battery, FIG. 8 provides a schematic illustration of a fluidic device 80 that incorporates or has its own battery. The fluidic device 80 can include a first layer 800 with an entry point 802 and a second layer 810 having an elongated functional wicking channel 812 that can be filled with a salt, for example sodium nitrite (NaNO₃). The wicking channel 812 affords for liquid to be wicked to two separate wicking channels 822 and 824 within a third layer 820, which can be in fluid communication with wicking channels 832 and 834 of a fourth layer 830. The wicking channel 832 can have a first metal salt, for example silver nitrate (AgNO₃), and the wicking channel 834 can have a second metal salt, for example aluminum chloride (AlCl₃)

A fifth layer 840 can extend across the fourth layer 840 and have a first metal 842, for example silver (Ag), and a second metal 844, for example aluminum (Al), in fluid communication with the first metal salt and the second metal salt, respectively. As such, when a liquid traverses from the entry point 802 through the wicking channels 832, 834 and comes into contact with the first and second metals 842, 844, an electrical conduit is afforded between the first and second metals 842 and 844 which can afford for a battery. Furthermore, when an electrical device is brought into contact with the first metal 842 and the second metal 844, electrical energy can be provided to the device. In some instances, a conductive third metal 846, for example copper or copper tape, can be placed into contact with the first and second metals 842, 844 to assist in connecting the metals to an electrical device. In addition, it is appreciated that the device shown in FIG. 8, and the following figures, are illustrated as separate unassembled layers for explanation purposes.

Another embodiment of a fluidic device providing a battery is shown in FIG. 9 at reference numeral 85. The device 85, similar to the device 80, can have a plurality of layers with functional wicking channels, a first metal salt, a second metal salt, a first metal, and a second metal. In particular, the first layer 850 having an opening 852 with a second layer 854 having a wicking channel 856 extending thereacross can be present. A third layer 860 with a pair of wicking channels 862, 864 can provide fluid communication between the wicking channel 856 and a pair of functional wicking channels 867, 868 of a fourth layer 866. Extending across the fourth layer 866 can be a fifth layer 870 having four wicking channels 872, 874, 876, 878 which afford for fluid communication between the pair of functional wicking channels 867, 868 and four functional wicking channels 882, 884, 886, 888 of a sixth layer 880. And then finally, a seventh layer 890 can have a pair of first metal portions 892, 896 and a pair of second metal portions 894, 898. With the arrangement of the pairs of first metals and second metals as shown in FIG. 9, a first piece of conductive tape 891 can be placed in contact with the first metal portion 894 and the second metal portion 896, a second conductive tape 893 can be placed in contact with the metal portion 892, and a third conductive tape portion 895 can be placed into contact with the metal portion 898 such that electrical contact between the conductive tape portions 893 and 895 provide two batteries hooked or connected in series.

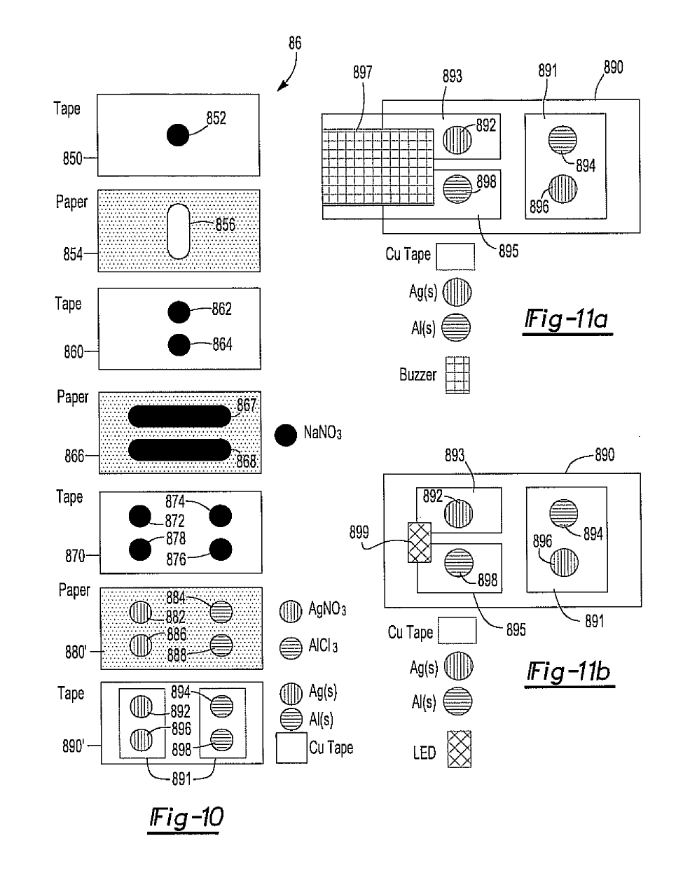

Regarding two batteries connected in parallel, FIG. 10 provides a schematic illustration of another embodiment for a fluidic device at reference numeral 86. The fluidic device 86 has the same first layer 850, second layer 854, third layer 860, fourth layer 866, and fifth layer 870. However, a sixth layer 880′ has a different arrangement of functional wicking channels 882-888 and the seventh layer 890′ has a different arrangement of the pair of first metal portions 892, 898 and second metal portions 894, 896. As shown in the figure, with one conductive tape portion 891 extending across and being in contact with the two metal portions 892 and 896 of the first metal portion and a second conductive tape portion 891 being in contact with the pair of second metal portions 894 and 898, a pair of batteries connected in parallel is provided.

FIGS. 11a and 11b illustrate the bottom layer 890, for example from the embodiment shown in FIG. 9, in which a buzzer 897 is placed into electrical contact with and across the conductive tape 893 and 895. It is appreciated that once a liquid that has been provided and placed into contact with opening 852 and has subsequently wicked through the device 85 as discussed above, contact with the metal portions 892-898 of layer 890 affords for electrical energy to be provided to the buzzer 897 such that an audible signal can be provided. Similarly, FIG. 11b illustrates a light emitting diode 899 in contact with the conductive tape 893 and 895 such that a light signal can be provided.

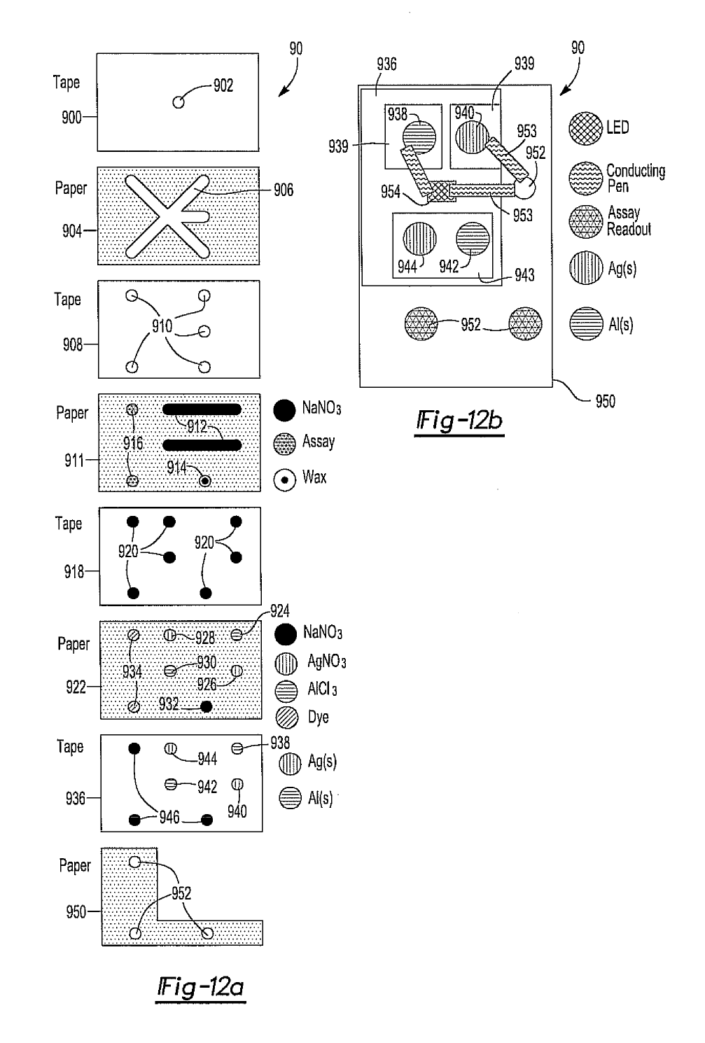

Turning now to FIGS. 12a and 12b, a combination of a fluidic timer, a chemical assay, and a battery is shown generally at reference numeral 90. The fluidic device 90 can include a first layer 900 having an opening 902 that may or may not have a wicking material therewithin. Second layer 904 has an elongated wicking channel 906 with a shape that affords for a fluid to wick therethrough and come into contact with a plurality of wicking channels 910 within a third layer 908. Thereafter, the liquid can come into contact with and wick through functional wicking channels 912, 914 and 916 at a fourth layer 911. For example and for illustrative purposes only, the wicking channels 912 can have a salt such as sodium nitrate, the wicking channel 914 can have a hydrophobic material such as paraffin wax, and the wicking channels 916 can be used as part of a chemical assay.

It is appreciated that the salt within the wicking channels 912 can provide an electrolyte, the wax within wicking channel 914 can delay wicking of the liquid therethrough and thereby provide at least part of a timer, and the assay chemicals within the wicking channels 916 can be at least part of a chemical assay test. Upon wicking through the fourth layer 911, the liquid can wick through a plurality of wicking channels 920 of a fifth layer 918 and come into contact with and wick through a plurality of wicking layers in a sixth layer 922. For example, liquid having wicked through the wicking channels 912 can come into contact with functional wicking channels 924, 926, 928 and 930 that include a first metal salt and a second metal salt. In addition, the wicking channel 932 can include a salt similar to that present within the wicking channels 912 and the wicking channels 934 can also include chemical assay chemicals. A seventh layer 936 can have first metal portions 938, 942 and second metal portions 940, 944 along with other wicking channels 946. The electrolyte provided by wicking channels 912, the first and second metal salts provided in wicking channels 924-930, and the first and second metals 938-944 provide a battery.

Referring in particular to FIG. 12b, an eighth layer 950 placed on the seventh layer 936 is shown. The seventh layer 936 has a pair of conductive tape portions 939 in contact with the first metal portion 938 and the second metal portion 940. In addition, a conductive tape portion 943 extends across and is in contact with the first metal portion 942 and the second metal portion 944. Conductive leads, for example conductive paint, can be in contact with an LED 954, the wicking channel 952, and the pair of conductive tape portions 939. In this configuration, electrical contact across the wicking channel 952 is not provided until the liquid wicks through the hydrophobic portion of 914 and the salt portion in wicking channel 932. In this manner, a timer can be provided for illuminating the LED 954, the time required for such activation of the LED 954 corresponding to a desired time for a chemical assay examination at wicking channels 952.

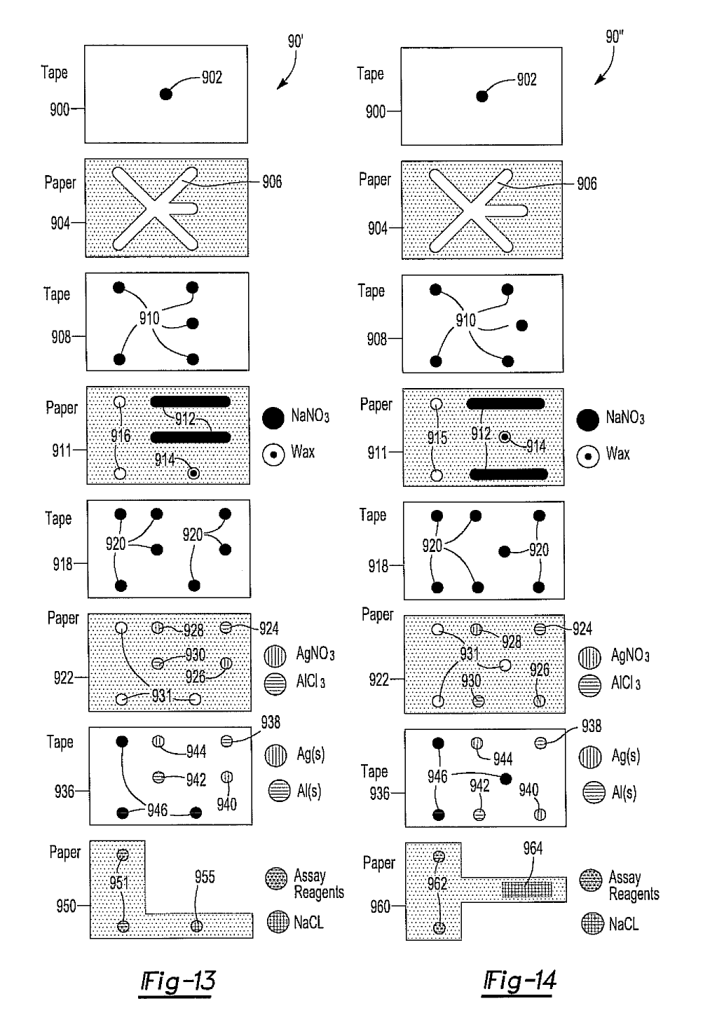

Another embodiment for a fluidic device having a timer, chemical assay, and a battery is shown in FIG. 13 at reference numeral 90′. Similar to the embodiment shown in FIG. 12, the embodiment 90′ includes a plurality of layers and wicking channels. However in the fluidic device 90′, a salt providing an electrolyte for wicking channel 952 is not provided until the eighth layer 950 and wicking channel 955. As such, any combination of layers and wicking channels can be used to provide battery power, a timer, and/or a chemical assay.

Another embodiment of such a fluidic device is shown in FIG. 14 at reference numeral 90″. In this embodiment, the functional wicking channels 912 and the wicking channel 914 have been rearranged; however, their function is the same. In addition, the eighth layer 960 can have a different shape but can serve the same purpose as being part of a battery, timer, and/or chemical assay.

It is appreciated that the first metal and second metal can be any metal, alloy and/or compound suitable for use as part of a battery and the electrolyte for the battery/galvanic cell can be any salt, compound, etc., that can provide a redox reaction as is known to those skilled in the art. For example and for illustrative purposes only, Table 1 provides a list of half-cell reactions representing a non-exhaustive list of such materials.

TABLE 1

| Volts | Reduction | | Half-Reaction |
|---|---|---|---|
| 2.87 | F₂ (g) | + | 2e⁻ → 2F⁻ (aq) |
| 1.36 | Cl₂ (g) | + | 2e⁻ → 2Cl⁻ (aq) |
| 1.20 | Pt²⁺ (aq) | + | 2e⁻ → Pt (s) |
| 0.92 | Hg²⁺ (aq) | + | 2e⁻ → Hg (l) |
| 0.80 | Ag⁺ (aq) | + | e⁻ → Ag (s) |
| 0.53 | I₂ (s) | + | 2e⁻ → 2l⁻ (aq) |
| 0.34 | Cu2+ (aq) | + | 2e⁻ → Cu (s) |
| 0 | 2H+ (aq) | + | 2e⁻ → H2 (g) |
| −0.13 | Pb²⁺ (aq) | + | 2e⁻ → Pb (s) |
| −0.26 | Ni²⁺ (aq) | + | 2e⁻ → Ni (s) |
| −0.44 | Fe²⁺ (aq) | + | 2e⁻ → Fe (s) |
| −0.76 | Zn²⁺ (aq) | + | 2e⁻ → Zn (s) |
| −1.66 | Al³⁺ (aq) | + | 3e⁻ → Al (s) |
| −2.71 | Na⁺ (aq) | + | e⁻ → Na (s) |
| −2.87 | Ca²⁺ (aq) | + | 2e⁻ → Ca (s) |
| −2.91 | K⁺ (aq) | + | e⁻ → K (s) |
| −3.04 | Li⁺ (aq) | + | e⁻ → Li (s) |

It is to be understood that various modifications are readily made to the embodiments of the present invention described herein without departing from the scope and spirit thereof. Accordingly, it is to be understood that the invention is not to be limited by the specific illustrated embodiments but by the scope of the appended claims.

We claim:

1. A fluidic device comprising:
a first layer having a first layer wicking channel therethrough;
a second layer extending across said first layer and having a second layer functional wicking channel therethrough; and
a third layer extending across said second layer and having a third layer functional wicking channel therethrough, said second layer functional wicking channel having a different function than said third layer functional wicking channel.

2. The fluidic device of claim 1, wherein said first, second and third layer wicking channels contain a cellulose material.

3. The fluidic device of claim 2, wherein said cellulose material is a paper.

4. The fluidic device of claim 1, wherein said second layer functional wicking channel contains a liquid-phobic portion, said liquid-phobic portion providing a delayed wicking rate through said second layer functional wicking channel.

5. The fluidic device of claim 4, wherein said liquid-phobic portion contains a hydrophobic material.

6. The fluidic device of claim 4, wherein said hydrophobic material is a paraffin wax.

7. The fluidic device of claim 1, wherein said third layer functional wicking channel contains a signaling portion.

8. The fluidic device of claim 7, wherein said signaling portion is colorimetric.

9. The fluidic device of claim 8, wherein said signaling portion is chemiluminescent.

10. The fluidic device of claim 1, wherein said second layer contains a plurality of spaced apart second layer functional wicking channels with one wicking channel containing a first amount of a liquid-phobic material and another wicking channel containing a second amount of a said liquid-phobic material.

11. The fluidic device of claim 10, wherein said third layer contains a plurality of spaced apart third layer functional wicking channels with one wicking channel containing a first color signaling portion and another wicking channel containing a second color signaling portion, said third layer one and another wicking channels in fluid communication with said second layer one and another wicking channels, respectively.

12. The fluidic device of claim 11, said second layer and said third layer each have a chemical assay wicking channel in fluid communication with each other, for performing a chemical assay on a liquid that wicks therethrough.

13. The fluidic device of claim 1, wherein said second layer functional wicking channel contains a salt, said salt providing an electrolyte when a liquid wicks through said second layer functional wicking channel.

14. The fluidic device of claim 13, wherein said third layer has a pair of spaced apart functional wicking channels in fluid communication with said second layer functional wicking channel, one of said pair of functional wicking channels containing a first metal salt and another of said pair of functional wicking channels containing a second metal salt.

15. The fluidic device of claim 14, further comprising a fourth layer extending across said third layer and containing a first metal and a second metal in fluid communication with said first metal salt and said second metal salt, respectively, of said pair of spaced apart third layer functional wicking channels, said second, third and fourth layers providing a battery when a liquid wicks through said second and third layer wicking channels and comes into contact with said first and second metals.

16. The fluidic device of claim 15, further comprising a sound generating device in electrical contact with said first metal and said second metal, said sound generating device operable to generate an audible signal when said liquid wicks through said second and third layers and comes into contact with said first and second metals.

17. The fluidic device of claim 16, wherein said sound generating device is a piezoelectric buzzer.

18. The fluidic device of claim 15, further comprising a light generating device in electrical contact with said first metal and said second metal, said light generating device operable to generate a visible signal when said liquid wicks through said second and third layers and comes into contact with said first and second metals.

19. The fluidic device of claim 18, wherein said light generating device is an LED.

20. The fluidic device of claim 15, further comprising a fifth layer extending between said first layer and said fourth layer, said fifth layer having a wicking channel containing a liquid-phobic portion operable to delay wicking therethrough and provide a timing function.
